(19) United States
(12) Patent Application Publication
(10) Pub. No.: US 2018/0222668 A1
(43) Pub. Date: Aug. 9, 2018

(54) A TRANSPORTATION SYSTEM FOR TRANSPORTATION OF LARGE ITEMS AND USE THEREOF

(71) Applicant: VIGGO JESPERSEN HOLDING APS, Skarup Fyn (DK)

(72) Inventor: Viggo Jespersen, Klingstrupvej 1 (DK)

(21) Appl. No.: 15/749,731

(22) PCT Filed: Jul. 8, 2016
(86) PCT No.: PCT/DK2016/050241

§ 371 Date: Feb. 1, 2018

(30) Foreign Application Priority Data
Aug. 5, 2015 (DK) PA 2015 00442

(51) Int. Cl. B65D 88/12; B65D 90/00

(52) U.S. Cl. CPC B65D 88/129; F03D 13/40; B65D 2590/0058; B65D 90/006

(57) ABSTRACT

The invention relates to a transportation system (100) for transportation of large items (2), such as flanges, wherein said transportation system comprises: a frame (4) having an extension in a longitudinal direction (X), in a transversal direction (Y) and in a vertical direction (Z); wherein said frame comprises two longitudinal girders (6,6′), which are connected to a plurality of pairs of transversal primary support beams (8,8′, 10,10′); wherein said primary support beams preferably are being arranged on an upper part of said longitudinal girders (6,6′); wherein said longitudinal girders comprise a lower surface (12) and an upper surface (14); wherein said transversal primary support beams comprise an upper surface (16); wherein the area between two transversal primary support beams defines a storage area (18) for said large items; wherein free access in a downward direction is provided in the storage area (18) for the large items; wherein the lower part of the frame (4) is having dimensions and locking mechanisms corresponding to a freight container; thereby allowing the transportation system to be arranged and locked in place safely on top of a freight container.

### FIELD OF THE INVENTION

The present invention relates in a first aspect to a transportation system for transportation of large items, such as flanges. In a second aspect the present invention relates to the use of a transportation system according to the first aspect for transportation of large items.

### BACKGROUND OF THE INVENTION

Within the wind turbine industry it well-known that the individual elements used for a wind turbine often are being manufactured at locations far away from the site on which the wind turbine is to be set up. This implies that certain challenges are encountered during transportation from the production site for the individual elements and the site itself of setting up of the wind turbine. This is not at least true in relation to large items or elements which are to be used for the erect wind turbine. These challenges in particular relate to difficulties and thereby associated expenses during transport of these large elements or items.

One example of a large element or item, which is used for erect wind turbines are flanges connecting the wind turbine tower with the wind turbine foundation. A flange for a wind turbine is usually manufactured from steel and comprises a circular ring in which the flange between the inner periphery and the outer periphery is provided with a plurality of through-going holes, whereby bolts may maintain the flange in a fastened configuration.

Flanges for wind turbines currently have an outer diameter of up to 9 m.

Various systems for transportation of flanges for wind turbines are known. Traditionally it has been common practice to transport flanges for wind turbines on a frame in a lying down or horizontally oriented configuration. In line with the ever increasing sizes of new wind turbine types also the flanges to be used will increase in size and thereby this horizontally oriented configuration of the flanges during transport becomes inconvenient, as the flanges in this orientation take up too much space during transport and during storing or storage.

WO 2012/146245 A1 discloses a system for transportation of flanges for wind turbines. This system comprises a frame having a rectangular shape. The frame comprises two longitudinal beams between which are arranged a number of support bars in a transversal direction. The support bars are configured for supporting a number of flanges which are vertically arranged in an orientation in such a way that their horizontal diameter is being parallel to the longitudinal beams. The individual flanges are being bolted together with threaded bars and moreover, the flanges are tethered to the frame using chains, rope or the like. It is mentioned in this document that the frame itself may be arranged on top of a pair of U-profiles during transport. The total height of the transportation system, including flanges, in this transportation system thereby becomes the height of the flanges plus the height of the U-profiles.

In particular in relation to shipment by ship, the total volume of the shipped cargo is of importance, as payment typically is calculated on the basis of volume, irrespective of weight.

Within the field of container freight the term “slot” is used. A “slot” designates a payment unit of the cargo to be shipped, a standard 20′ container defining a volume of 1“slot”. A 40′ container accordingly takes up a volume of 2 “slots”.

In an event where the cargo to be shipped takes up more space in height than what corresponds to a 20′ container, payment is being made in a way where the shipped volume is being added additional slots in height corresponding to the number of 20′ container space this cargo takes up in height.

Accordingly, cargo which in length takes up space corresponding to a 20′ container and which in height corresponds to 1.5 times the height of a 20′ container will be settled as taking up 2 slots (2 slots in height and 1 slot lengthwise). Similarly, cargo which in length takes up space corresponding to a 40′ container and which in height corresponds to 2.5 times the height of a 40′ container (having the same height as a 20′ container) will be settled as taking up 6 slots (3 slots in height and 2 slots lengthwise).

Accordingly, it is clear that when large elements or items are being transported as container freight it is of paramount importance for transport economy and thereby also for the total economy associated with the large elements or items that volume of the transported cargo is kept at a minimum.

Hence, a need persists for an improved transportation system for transportation of large items, such as flanges, for example for wind turbines, which allows transport of such large items while taking up a minimum of space.

It is an objective of the present invention to provide such transportation systems.

Kort Beskrivelse of Den Foreliggende Opfindelse

This objective is fulfilled with the present invention in its first and second aspect, respectively.

Accordingly, the present invention in its first aspect relates to a transportation system for transportation of large items, such as flanges, wherein said transportation system comprises:

a frame having an extension in a longitudinal direction, in a transversal direction and in a vertical direction;

wherein said frame comprises two longitudinal girders, which are connected to a plurality of pairs of primary support beams;

wherein said longitudinal girders comprise a lower surface and an upper surface;

wherein said transversal primary support beams comprise an upper surface;

wherein said primary support beams preferably are being arranged on an upper part of said longitudinal girders;

wherein the area between two transversal primary support beams defines a storage area for said large items;

wherein free access in a downward direction is provided in the storage area for the large items;

wherein the lower part of the frame is having dimensions and locking mechanisms corresponding to a freight container; thereby allowing the transportation system to be arranged and locked in place safely on top of a freight container.

The present invention relates in its second aspect to the use of a transportation system according the first aspect of the invention for transportation of large items, such as flanges.

With the present invention in its first and second aspect, respectively, it can be attained that large items or elements, such as flanges for wind turbines may be transported and stored, while taking up a minimum of space.

By using the transportation system according to the first aspect of the invention large harbour cranes may lift large items, such as flanges, off ships just like an ordinary container, the large items being arranged on a frame allowing such lift. Subsequently ordinary container movers may move around the flanges on the dock for the purpose of further transportation.

### BRIEF DESCRIPTION OF THE FIGURES

FIG. 1 shows an embodiment of a transportation system according to the present invention, as seen from above.

FIG. 2 shows the embodiment of FIG. 1 in a cross-sectional view.

FIG. 3a shows an embodiment of a transportation system according to the present invention during storage of flanges, as seen in a side view.

FIG. 3b shows the embodiment of FIG. 3a, as seen from above.

FIG. 3c shows the embodiment of FIG. 3a, as seen in an end view.

FIG. 4a shows an embodiment of a secondary support beam for use with the transportation system according to the present invention, as seen in a side view.

FIG. 4b shows the embodiment of FIG. 4a, as seen from above.

FIG. 4c shows the embodiment of FIG. 4a, as seen in an end view.

FIG. 5a shows an embodiment of a transportation system according to the present invention during storage of flanges, as seen in a side view.

FIG. 5b shows the embodiment of FIG. 5a, as seen from above.

FIG. 5c shows the embodiment of FIG. 5a, as seen in an end view.

### DETAILED DESCRIPTION OF THE PRESENT INVENTION

The first aspect of the present invention relates to a transportation system for transportation of large items, such as flanges, wherein said transportation system comprises:

a frame having an extension in a longitudinal direction, in a transversal direction and in a vertical direction;

wherein said frame comprises two longitudinal girders, which are connected to a plurality of pairs of primary support beams;

wherein said primary support beams preferably are being arranged on an upper part of said longitudinal girders;

wherein said longitudinal girders comprise a lower surface and an upper surface;

wherein said transversal primary support beams comprise an upper surface;

wherein the area between two transversal primary support beams defines a storage area for said large items;

wherein free access in a downward direction is provided in the storage area for the large items;

wherein the lower part of the frame is having dimensions and locking mechanisms corresponding to a freight container; thereby allowing the transportation system to be arranged and locked in place safely on top of a freight container.

With the transportation system according to the first aspect of the present invention it is possible in an easy and space saving way to store and transport large items or elements, such as flanges for wind turbines.

In the present description and in the appended claims the terms large elements or large items shall be understood to mean elements or items, which in their largest extension are having an extension of 3 m or more, such as 4 meters or more, for example 5 meters or more, such as 6 meters or more, for example 7 m or more, such as 8 m or more, or even 9 m or more.

In the present description and in the appended claims the term large elements or large items are specifically to be understood as being flanges for wind turbines.

A flange for a wind turbine is in the present description and in the appended claims is to be understood as a (compared to its other dimensions) relative flat, ring shaped element having a through-going hole in its centre. Accordingly, a flange is delimited by an inner periphery and an outer periphery. Between the inner and the outer periphery are typically arranged a number of through-going holes for accommodation of bolts for the purpose of fastening the flange. The number of through-going holes may be 10-200 or more, such as 20-190, e.g. 30-180, such as 40-170, e.g. 50-160, such as 60-150, e.g. 70-140, such as 80-130, e.g. 90-120 or 100-110.

The saving of space which is attained during storage and transport of especially flanges using the transportation system according to the first aspect of the present invention is brought about in that the flanges are resting on the transversal primary support beams which are arranged on an upper part of the longitudinal girders. Hereby is assured that the lower part of the flange, in the storage area between two primary support beams, is extending downward, preferably all the way down to the height of the lower surface of the longitudinal girders. Hereby space is saved in a vertical direction.

In order for this to take place, it is a requirement that the storage area between two primary support beams are providing free access to flanges, downwardly.

With the term “free access downwardly” shall in the present description and in the appended claims be understood that the storage area between two primary support beams is not obstructed or blocked by constructional elements or other parts which may prevent placement of flanges between two primary support beams in a way so that a lower part of the flange is extending downwardly towards the plane which is defined by the lower surfaces of the longitudinal girders.

In a preferred embodiment of the transportation system according to the first aspect of the invention the upper surface of the primary support beams is being arranged on the longitudinal girders in a height corresponding to at least 50%, such as 55%, such as at least 60%, for example at least 65%, such as at least 70%, for example at least 75%, such as at least 80%, such as at least 85% or at least 90% of the extension, in a vertical direction, of the longitudinal girders.

In a preferred embodiment of the transportation system according to the first aspect of the invention the upper surface of the primary support beams is being arranged on the longitudinal girders in a height above the longitudinal girder's lower surface of 300 mm or more, such as 350 mm or more, such as 400 mm or more, for example 450 mm or more, such as 500 mm or more, such as 550 mm or more, for example 600 mm or more.

These heights of placement of the primary support beams ensure sufficient distance downwardly in a way so that a beneficial saving of space in a vertical direction may be achieved.

In a preferred embodiment of the transportation system according to the first aspect of the invention the number of pairs of primary support beams is being 1, 2, 3 or 4.

These numbers of primary support beams ensure easy and convenient transportation and storage of flanges having a size that currently are used for wind turbines.

In a preferred embodiment of the transportation system according to the first aspect of the invention the upper surface of each primary support beam is inclined inwardly towards the storage area for the large items.

Each of the primary support beams is preferably inclined inwardly towards the storage area for the large items at an angle, relative to horizontal, of 5-40°, such as 10-35°, for example 15-30°, such as 20-25°.

These inclinations of the upper surface of each primary support beam ensure a larger contact surface between the flange and the primary support beam, which in turn implies less mechanical stress on the surface of the flange.

In a preferred embodiment of the transportation system according to the first aspect of the invention the mutual distance, in a longitudinal direction, between the most proximal points on the upper surface of the primary support beams of a pair of support beams is being 2000-3500 mm, such as 2100-3400 mm, such as 2200-3300 mm, for example 2300-3200 mm, such as 2200-3100 mm, for example 2300-3000 mm, for example 2400-2900 mm, such as 2500-2800 mm or 2600-2700 mm.

These mutual distances ensure easy and convenient transportation and storage of flanges having a size currently used for wind turbines.

In a preferred embodiment of the transportation system according to the first aspect of the invention the extension, in a vertical direction, of the longitudinal girders is being 300-900 mm, such as 400-800 mm for example 500-600 mm.

These vertical extensions of the longitudinal girders enable sufficient distance downwardly for flanges being arranged on a pair of primary support beams in such a way that a favourable saving of space in a vertical direction is achieved.

In a preferred embodiment of the transportation system according to the first aspect of the invention the primary support beams are being arranged, in a longitudinal and vertical position, on the longitudinal girders in such a way that a flange which is being arranged vertically on the support beams and which is arranged in a longitudinal orientation, does not extend beyond the longitudinal extension of the frame, in a situation in which the flanges are having a diameter of up to 9 m.

Hereby safe and easy transportation and storage of flanges having a diameter of up to 9 m is ensured in that the flanges do not take up more space in a horizontal plane than a standard freight container.

In a preferred embodiment of the transportation system according to the first aspect of the invention the lower part of the frame is having dimensions and locking mechanisms corresponding to a standard freight container, such as a standard 20′ or a standard 40′ freight container, such as a “flat rack” container; such as conventionally and/or traditionally used for transportation by ship.

In a preferred embodiment of the transportation system according to the first aspect of the invention the transportation system, in relation to the dimensions and locking mechanism of the lower part of the frame, complies with the ISO 668:2013 standard and/or the ISO 1496-1:2013 standard.

Hereby is ensured that the transportation system according to the invention, during storage and transportation, may be stacked on top of other standard freight containers.

In a preferred embodiment of the transportation system according to the first aspect of the invention the frame comprises a number of pairs of brackets for accommodating secondary support beams;

wherein each bracket is being arranged opposite to another on its respective longitudinal girder at a position in a longitudinal direction, corresponding to a storage area for large items;

wherein each pair of brackets comprises a number of cavities which are being arranged in a longitudinal direction for accommodating an end of a secondary support beam.

In a preferred embodiment of the transportation system according to the first aspect of the invention the number of pairs of brackets is being 1, 2 or 3 in respect of each storage area for large items.

In a preferred embodiment of the transportation system according to the first aspect of the invention the transportation system furthermore comprising one or more pairs of secondary support beams.

Hereby is enabled storage and transportation of two sizes of flanges, the larger flanges resting on a pair of primary support beams, and the smaller flanges being arranged within the larger flanges, wherein the smaller flanges rest on a pair of these secondary support beams.

In a preferred embodiment of the transportation system according to the first aspect of the invention each secondary support beam comprises an H-profile having welded thereon cylindrical bars in each end thereof.

Hereby the secondary beams may rotate in their respective cavities, whereby maximizing contact surface between the surface of the secondary support beams and the surface of the flanges is obtained. This ensures minimizing the physical stress on the surface of the flanges.

In a preferred embodiment of the transportation system according to the first aspect of the invention the frame comprises a pair of storage beams for storing one or more pairs of secondary support beams; the storage beams preferably being arranged on the longitudinal girders at a position outside the storage area for the large items.

Hereby it is possible to store the secondary support beams together with the rest of the transportation system when the secondary support beams are not used.

In a preferred embodiment of the transportation system according to the first aspect of the invention the frame in its end(s) comprises one or two end wall(s).

In a preferred embodiment of the transportation system according to the first aspect of the invention the end wall(s) comprises means for pivoting said end wall(s) between a vertical, upright configuration and a horizontal, inwardly folded-down configuration and vice versa.

Hereby the transportation system may be packed into a compact configuration for the purpose of saving storage space when not in use.

In a preferred embodiment of the transportation system according to the first aspect of the invention the end wall(s) is/are having dimensions and locking mechanism corresponding to a standard 20′ or 40′ freight container.

Hereby the transportation system may be lifted by the type of cranes usually employed for lifting freight containers.

In a preferred embodiment of the transportation system according to the first aspect of the invention each primary support beam of one or more pairs of primary support beams is being pivotally suspended, via pivoting mechanisms, such as suspension bearings, on said longitudinal girders in such a way that they are able to being rotated around their longitudinal axes.

Hereby an automatic maximization of the contact surface between the primary support beams and the surface of the flanges is ensured.

In a preferred embodiment of the transportation system according to the first aspect of the invention the transportation system comprising two primary support beams, wherein at least one primary support beam is being movably mounted on the longitudinal girders via fastening means therefor.

Such fastening means may for example comprise a number of threaded holes, displaced in a longitudinal direction on the longitudinal girders, and a number of bolts, whereby at least one of the primary support beam hereby may be bolted and fastened to the longitudinal girders.

Hereby is ensured that even flanges having a diameter of up to 9 m or more may be stored and transported with the transportation system according to the present invention.

In a preferred embodiment of the transportation system according to the first aspect of the invention the transportation system comprising a number of bolts or threaded bars, nuts and flexible fastening means, such as wires, chains, straps or ropes, wherein each bolt/threaded bar is being configured for fastening in through-going holes in one or more flanges, and wherein the fastening means are being configured for allowing fastening of one or more flanges, in an upright orientation, to the transportation system, when the flange(s) is/are resting on the transversal support beams and/or the secondary support beams.

Such means ensure safe and efficient fixing of the flanges in the transportation system.

The second aspect of the invention relates to a use of a transportation system according to the first aspect of the invention for transportation of large items, such as flanges.

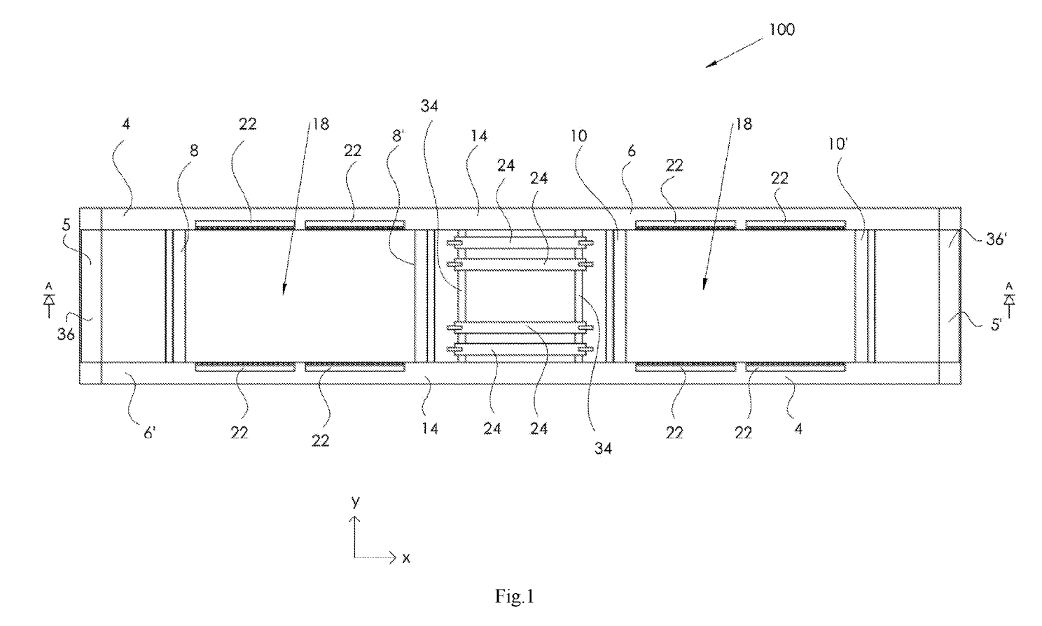

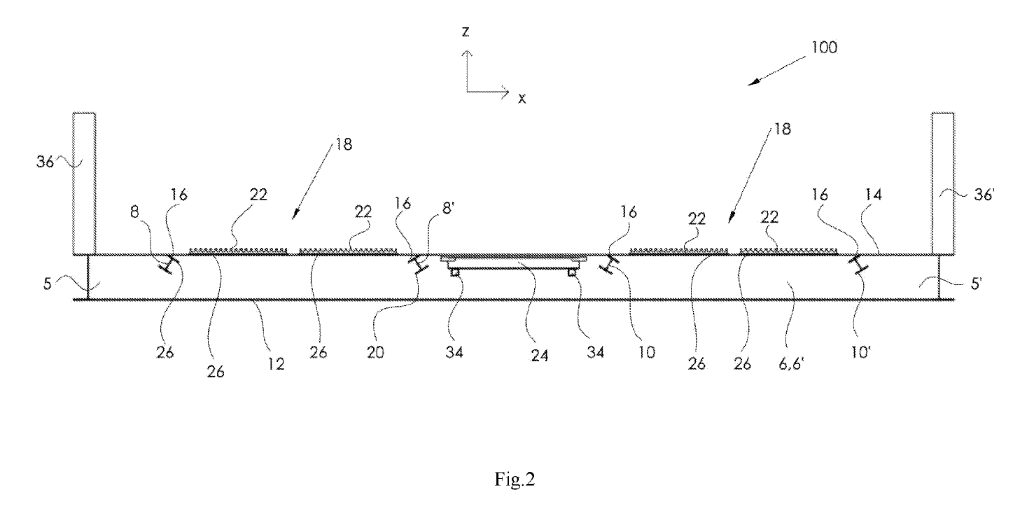

Referring now to the drawings for the purpose of illustrating the present invention, FIG. 1 shows an embodiment of a transportation system according to the present invention as seen from above, and FIG. 2 shows the same embodiment as seen in the section A-A. In FIGS. 1 and 2 is seen a transportation system 100 for transportation of large items, such as flanges. The transportation system comprises a frame 4 having an extension in a longitudinal direction X, in a transversal direction Y and in a vertical direction Z.

The frame comprises two longitudinal girders 6,6′ which are connected to a plurality of transversal support beams 8,8′, 10,10′, each of which comprises a lower surface 12 and an upper surface 14.

The primary support beams are arranged on the longitudinal girders 6,6′ and comprise an upper surface 16. The area between the two primary support beams defines a storage area 18 for the large items.

As the primary support beams are arranged on an upper part of the longitudinal girders 6,6′ and as the storage area 18 for the large items provides free access downwardly it is possible that large items, such as flanges may be arranged on top on the primary support beams in a vertical orientation and in an orientation in which the flange's horizontal diameter essentially is parallel with the longitudinal girders 6,6′ and hence it is attained that that the large items can rest on the primary support beams 8,8′ or 10,10′ in a way where the bottom of the flanges extends all the way or almost all the way to the lower surface 12 of the girders. In this way space is saved in a vertical direction during storage and transport of the flanges.

The primary support beams 8,8′ or 10,10′ may in the general case carry a number of large items or flanges, such as 4-26, for example 6-24, such as 8-22, for example 10-20, such as 12-18 or 14-16 large items or flanges.

As the lower part of the frame 4 is having dimensions and locking mechanisms corresponding to a standard freight container the transportation system may be arranged and locked securely on top of a standard freight container. Herby the transportation system may be shipped as a container.

In FIG. 2 is seen that the primary support beams 8,8′,10,10′ is pivoted into an orientation wherein their upper surface 16 is inclined inwardly towards the storage area 18 for large items. In this way a larger contact surface and hence a lower pressure is being exerted on the large items, when these are resting on the support beams.

FIGS. 1 and 2 also shows a number of secondary support beams 24. These are being stored on two storage beams 34 which are arranged outside the storage areas 18 for the large items.

Furthermore, FIGS. 1 and 2 show a number of pairs of brackets 22 for accommodation of secondary support beams 24. Each bracket 22 is arranged opposite to another on its respective longitudinal girder 6,6′ at a position in a longitudinal direction X which corresponds to the storage area 18 for large items 2.

It is seen that each bracket 22 comprises a number of cavities 26 which are arranged in a longitudinal direction X for accommodation an end 28 of a secondary support beam 24.

The secondary support beams 34 may be used for supporting, during transport or storage, of large items or elements 2, such as flanges, which are slightly smaller than the large items 2, such as flanges being supported by the primary support beams 8,8′,10,10′.

Hereby the space being available within the large items 2, which are being supported on the primary support beams 8,8′, 10, 10′, is utilised, when two sizes of flanges are to be stored or transported.

When the secondary support beams are not used, they may conveniently be stored on the storage beams 34.

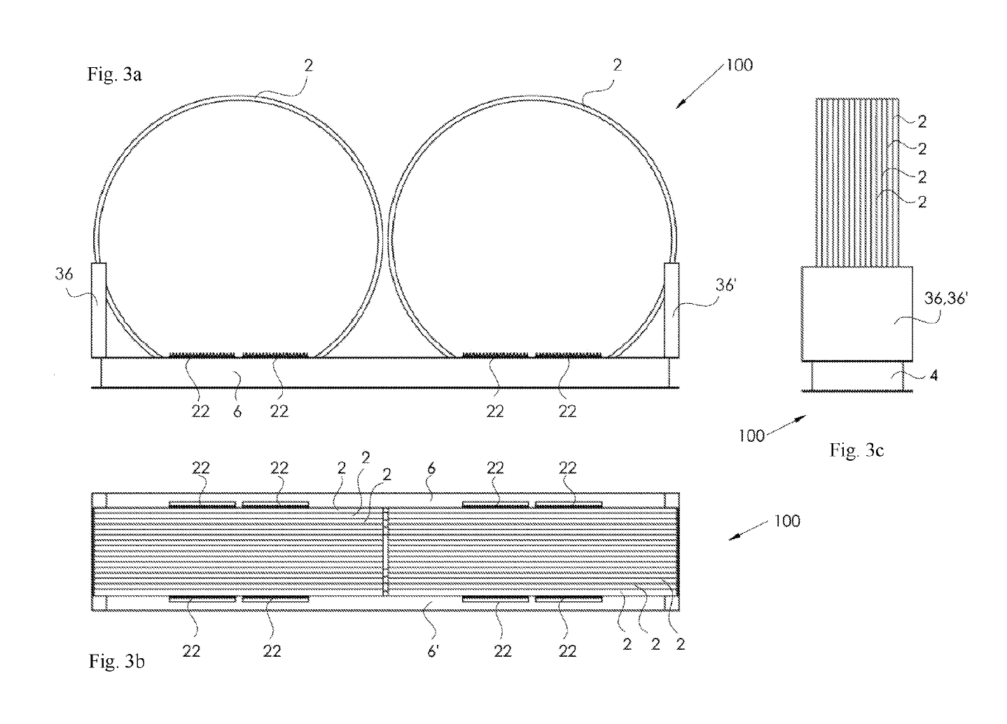

In FIG. 3a is shown in a side view the transportation system of FIGS. 1 and 2, in which the two storage areas 18 for large items are accommodated by 15 flanges which rest on the two pairs of primary support beams 8,8′ and 10,10′ respectively.

FIG. 3b shows this situation as seen from above and FIG. 3c shows the same situation as seen in an end view.

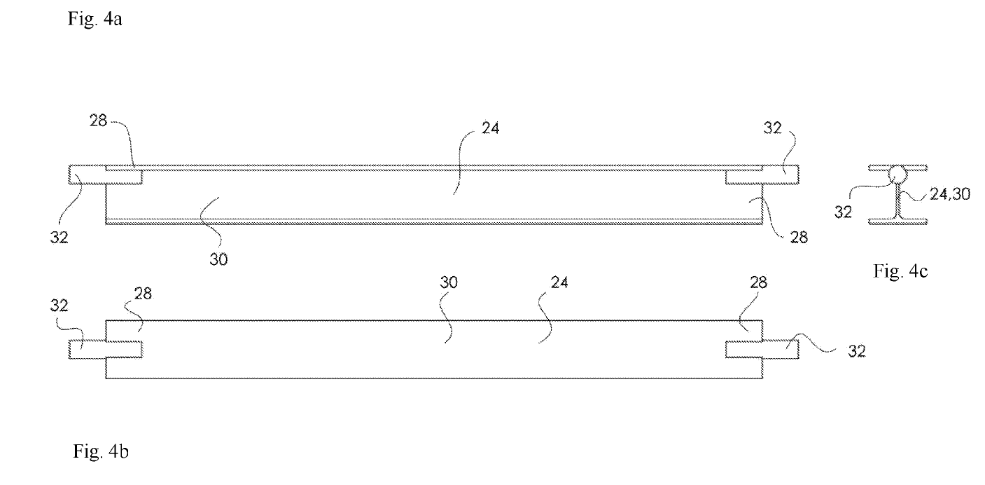

In FIGS. 4a, 4b and 4c are shown an example of a secondary support beam 24 for use with the transportation system according to the present invention, as seen in a side view, from above and in an end view, respectively.

This secondary support beam comprises an H-profile 30 which in each of its ends has welded on a cylindrical bar 32.

Accordingly, the secondary support beams 24 are loose and the distance between pairs of secondary support beams 24, during use for transport, may be adjusted, by selecting the mutual distance via placement in the appropriate cavities 26 in the brackets 22.

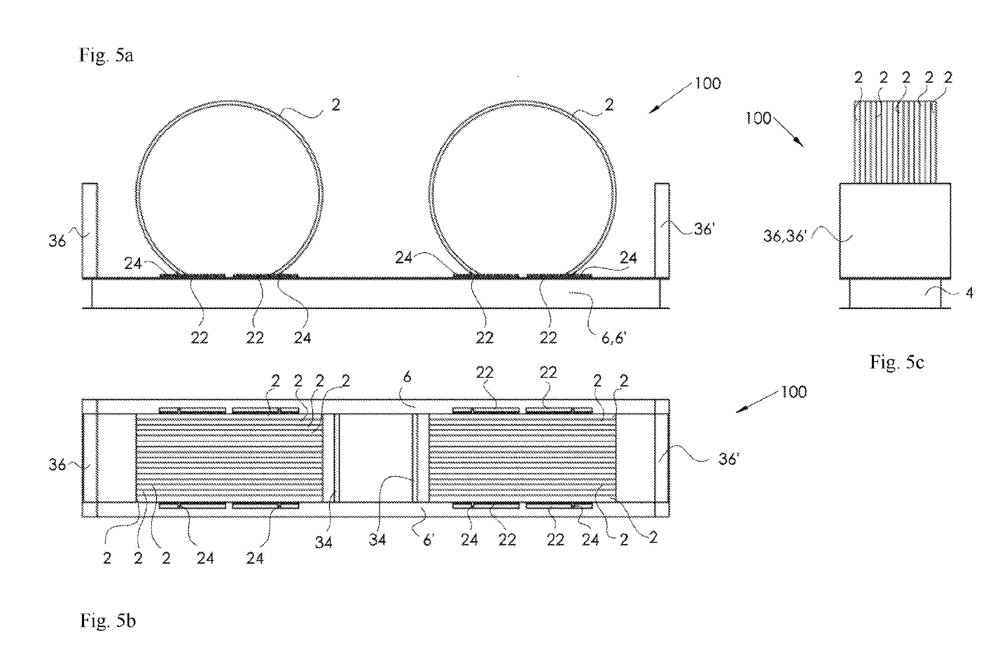

In FIG. 5a is shown, seen in a side view, the transportation system of FIGS. 1 and 2, in which the two storage areas 18 for large items are accommodated by 15 flanges, which are resting on the two pairs of secondary support beams 24.

FIG. 5b shows this situation as seen from above and FIG. 5c shows the same situation as seen in an end view.

The flanges being shown in FIGS. 5a, 5b and 5c are smaller than the flanges being shown in FIGS. 3a, 3b and 3c.

The two situations being depicted in FIGS. 3a, 3b and 3c on the one hand, and in FIGS. 5a, 5b and 5c on the other hand may be combined in that first, the large flanges 2 in a way illustrated in FIGS. 3a, 3b and 3c are mounted, and subsequently mounting the slightly smaller flanges 2, being illustrated in FIGS. 5a, 5b and 5c, within the larger flanges.

The large items, such as flanges, may be tethered to the transportation system by using a number of bolts 40, nuts 42 and flexible mounting means 44, such as wires, chains, straps or ropes (not illustrated in the drawings), wherein each bolt being configured to be mounted in through-going holes in one or more items or flanges 2, and wherein the fastening means are being configured to allow fastening of one or more items or flanges in an upright orientation to the transportation system, when the item(s) or flange(s) rest(s) on the transversal primary support beams 8,8′,10,10′ and/or on the secondary support beams 24.

Moreover, the transportation system according to the present invention may comprise one or more spacers for being arranged between flanges for attaining further safety and fixation of the large items, such as flanges.

### REFERENCES TO FIGURES

2 Large items

4 Frame

5,5′ End of frame

6,6′ Longitudinal girder

8,8′,10,10′ Transversal primary support beams

12 Lower surface of longitudinal girder

14 Upper surface of longitudinal girder

16 Upper surface of primary support beam

18 Storage area for large item

20 Proximal points on upper surface of primary support beams

22 Bracket for accommodation of secondary support beams

24 Secondary support beam

26 Cavity in bracket for accommodation of secondary support beam

28 End of secondary support beam

30 H-profile of secondary support beam

32 Cylindrical bar of secondary support beam

34 Storage beam for storing secondary support beams

36,36′ End wall of frame

38,38′ Means for pivoting end wall

40 Bolt

42 Nut

44 Flexible fastening means

100 Transportation system

1. A transportation system for transportation of large items, such as flanges, wherein said transportation system comprises:
a frame having an extension in a longitudinal direction, in a transversal direction and in a vertical direction;
wherein said frame comprises two longitudinal girders, which are connected to a plurality of pairs of primary support beams;
wherein said primary support beams preferably are being arranged on an upper part of said longitudinal girders;
wherein said longitudinal girders comprise a lower surface and an upper surface;
wherein said transversal primary support beams comprise an upper surface;
wherein the area between two transversal primary support beams defines a storage area for said large items;
wherein free access in a downward direction is provided in the storage area for the large items;
wherein the lower part of the frame is having dimensions and locking mechanisms corresponding to a freight container; thereby allowing the transportation system to be arranged and locked in place safely on top of a freight container.

2. A transportation system according to claim 1, wherein the upper surface of the primary support beams is being arranged on the longitudinal girders in a height corresponding to at least 50%, such as 55%, such as at least 60%, for example at least 65%, such as at least 70%, for example at least 75%, such as at least 80%, such as at least 85% or at least 90% of the extension, in a vertical direction, of the longitudinal girders.

3. A transportation system according to claim 1, wherein the upper surface of the primary support beams is being arranged on the longitudinal girders in a height above the longitudinal girder's lower surface of 300 mm or more, such as 350 mm or more, such as 400 mm or more, for example 450 mm or more, such as 500 mm or more, such as 550 mm or more, for example 600 mm or more.

4. A transportation system according to any of the preceding claims 1, wherein the number of pairs of primary support beams is being 1, 2, 3 or 4.

5. A transportation system according to claim 4, wherein the upper surface of each primary support beam is inclined inwardly towards the storage area for the large items.

6. A transportation system according to claim 5, wherein the upper surface of each of the primary support beams is inclined inwardly towards the storage area for the large items at an angle, relative to horizontal, of 5-40°, such as 10-35°, for example 15-30°, such as 20-25°.

7. A transportation system according to claim 1, wherein the mutual distance, in a longitudinal direction, between the most proximal points on the upper surface of the primary support beams of a pair of support beams is being 2000-3500 mm, such as 2100-3400 mm, such as 2200-3300 mm, for example 2300-3200 mm, such as 2200-3100 mm, for example 2300-3000 mm, for example 2400-2900 mm, such as 2500-2800 mm or 2600-2700 mm.

8. A transportation system according to any of the preceding claim 1, wherein the extension, in a vertical direction, of the longitudinal girders is being 300-900 mm, such as 400-800 mm for example 500-600 mm.

9. A transportation system according to any of the preceding claim 1, wherein the primary support beams are being arranged, in longitudinal and vertical position, on the longitudinal girders in such a way that a flange which is being arranged vertically on the support beams and which is arranged in a longitudinal orientation, does not extend beyond the longitudinal extension of the frame, in a situation in which the flanges are having a diameter of up to 9 m.

10. A transportation system according to any of the claim 1, wherein the lower part of the frame is having dimensions and locking mechanisms corresponding to a standard freight container, such as a standard 20′ or a standard 40′ freight container, such as a “flat rack” container; such as conventionally and/or traditionally used for transportation by ship.

11. A transportation system according to claim 10 which, in relation to the dimensions and locking mechanism of the lower part of the frame, complies with the ISO 668:2013 standard and/or the ISO 1496-1:2013 standard.

12. A transportation system according to claim 1, wherein the frame comprises a number of pairs of brackets for accommodating secondary support beams;
wherein each bracket is being arranged opposite to another on its respective longitudinal girder at a position in a longitudinal direction, corresponding to a storage area for large items;
wherein each pair of brackets comprises a number of cavities which are being arranged in a longitudinal direction for accommodating an end of a secondary support beam.

13. A transportation system according to claim 12, wherein the number of pairs of brackets is being 1, 2 or 3 in respect of each storage area for large items.

14. A transportation system according to claim 12 furthermore comprising one or more pairs of secondary support beams.

15. A transportation system according to claim 14, wherein each secondary support beam comprises an H-profile having welded thereon cylindrical bars in each end thereof.

16. A transportation system according to any of the claim 12, wherein the frame comprises a pair of storage beams for storing one or more pairs of secondary support beams; the storage beams preferably being arranged on the longitudinal girders at a position outside the storage area for the large items.

17. A transportation system according to any of the claim 16, wherein the frame in its end(s) comprises one or two end wall(s).

18. A transportation system according to claim 17 wherein the end wall(s) comprise(s) means for pivoting said end wall(s) between a vertical, upright configuration and a horizontal, inwardly folded-down configuration and vice versa.

19. A transportation system according to claim 17 wherein the end wall(s) is/are having dimensions and locking mechanism corresponding to a standard 20′ or 40′ freight container.

20. A transportation system according to any of the claim 1, wherein each primary support beam of one or more pairs of primary support beams is being pivotally suspended, via pivoting mechanisms, such as suspension bearings, on said longitudinal girders in such a way that they are able to being rotated around their longitudinal axes.

21. A transportation system according to claim 20 comprising two primary support beams, wherein at least one primary support beam is being movably mounted on the longitudinal girders via fastening means therefor.

22. A transportation system according to claim 20 furthermore comprising a number of bolts, nuts and flexible fastening means, such as wires, chains, straps or ropes, wherein each bolt is being configured for fastening in through-going holes in one or more flanges, and wherein the fastening means are being configured for allowing fastening of one or more flanges, in an upright orientation, to the transportation system, when the flange(s) is/are resting on the transversal support beams and/or the secondary support beams.

23. Use of a transportation system according to claim 1 for transportation of large items, such as flanges.
